(19) United States
(12) Patent Application Publication
(10) Pub. No.: US 2026/0084636 A1
(43) Pub. Date: Mar. 26, 2026

(54) TRIGGERING USAGE RECOMMENDATIONS BASED ON HISTORICAL GEO-LOCATION DATA

(71) Applicant: Thor Tech, Inc., Elkhart, IN (US)

(72) Inventors: Chris Cook, Minneapolis, MN (US); Chris Pendl, Seattle, WA (US)

(73) Assignee: Thor Tech, Inc., Elkhart, IN (US)

(21) Appl. No.: 19/334,338

(22) Filed: Sep. 19, 2025

Related U.S. Application Data
(60) Provisional application No. 63/697,457, filed on Sep. 21, 2024.
(60) Provisional application No. 63/697,458, filed on Sep. 21, 2024.

(51) Int. Cl. B60R 16/023; G01C 21/34; G06F 16/906; G06F 16/9537; G07C 5/04

(52) U.S. Cl. CPC B60R 16/0231; G01C 21/3484; G06F 16/906; G06F 16/9537; G07C 5/04

(57) ABSTRACT

Embodiments provided herein include systems and methods for triggering usage recommendations. One embodiment of a method includes recording past trip data, where the past trip data includes data associated with at least one past trip taken in the RV, determining non-use of the RV, where determining non-use of the RV includes determining a duration since a most recent past trip, and classifying the user based on the non-use and the past trip data. Some embodiments include recommending, based on the classification and the past trip data, a new trip for the RV, determining operational data to enhance the new trip, where the operational data is associated with the at least one operational system, and providing data associated with the new trip and the operational data to the user.

### CROSS REFERENCE

This application claims the benefit of U.S. Provisional Application Ser. No. 63/697,457 entitled Triggering Usage Recommendations based on Historical Geo-Location Data, filed Sep. 21, 2024, and U.S. Provisional Application Ser. No. 63/697,458 entitled Triggering Usage Recommendations based on Geo-Fenced Points of Interest, filed Sep. 21, 2024, both of which are hereby incorporated by reference in their entireties.

### BACKGROUND

Recreational vehicles (RVs) are becoming more popular and, as a consequence, are becoming more sophisticated. As the popularity of these RVs increases, there are user demands of greater functionality. As an example, an RV owner or user may inadvertently forget to use the RV. This can occur because the user is too busy, but oftentimes the non-use is a result of not fully understanding the functionality provided or the travel options available.

Similarly, when an RV owner or user is using the RV, he/she may take a trip to a campsite. Upon arriving at the campsite, the user/owner may not know exactly the best camping spot to set up camp. As such, a need exists in the industry for triggering usage recommendations based on historical geo-location data.

### SUMMARY

Systems and methods for triggering usage recommendations are provided. One embodiment of a method includes recording past trip data, where the past trip data includes data associated with at least one past trip taken in the RV, determining non-use of the RV, where determining non-use of the RV includes determining a duration since a most recent past trip, and classifying the user based on the non-use and the past trip data. Some embodiments include recommending, based on the classification and the past trip data, a new trip for the RV, determining operational data to enhance the new trip, where the operational data is associated with the at least one operational system, and providing data associated with the new trip and the operational data to the user.

One embodiment of a system includes a recreational vehicle (RV) for carrying a user that includes at least one operational system, where the at least one operational system is configured to provide a function to improve operation of the RV. The system may also include a computing device that includes a processor and memory component. The memory component may store logic, that when executed by the processor, causes the system to record past trip data, where the past trip data includes data associated with at least one past trip taken in the RV, determine non-use of the RV, where determining non-use of the RV includes determining a duration since a most recent past trip, and classify the RV based on the non-use and the past trip data. In some embodiments, the logic causes the system to recommend, based on the classification and the past trip data, a new trip for the RV, determine operational data to enhance the new trip, where the operational data is associated with the at least one operational system, and provide data associated with the new trip and the operational data to the user.

These and additional features provided by the embodiments of the present disclosure will be more fully understood in view of the following detailed description, in conjunction with the drawings.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

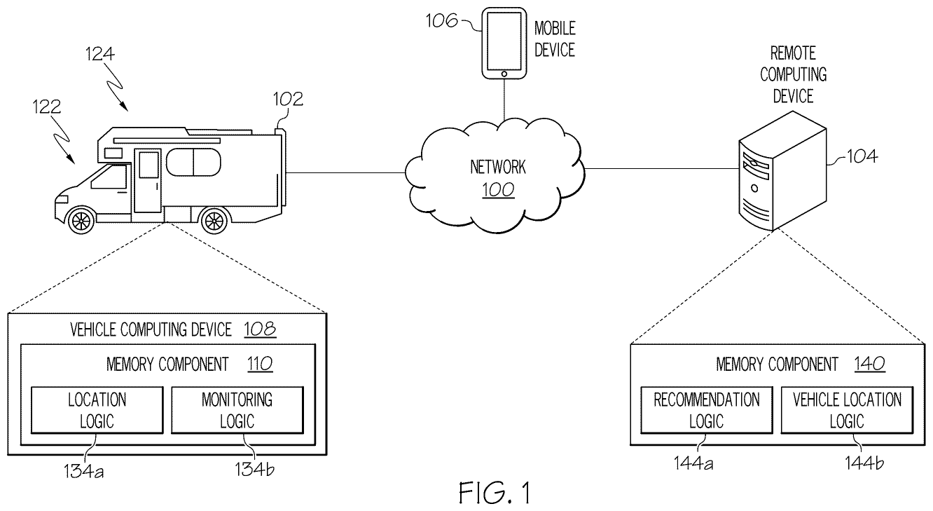

FIG. 1 depicts a computing environment for triggering usage recommendations, according to embodiments provided herein;

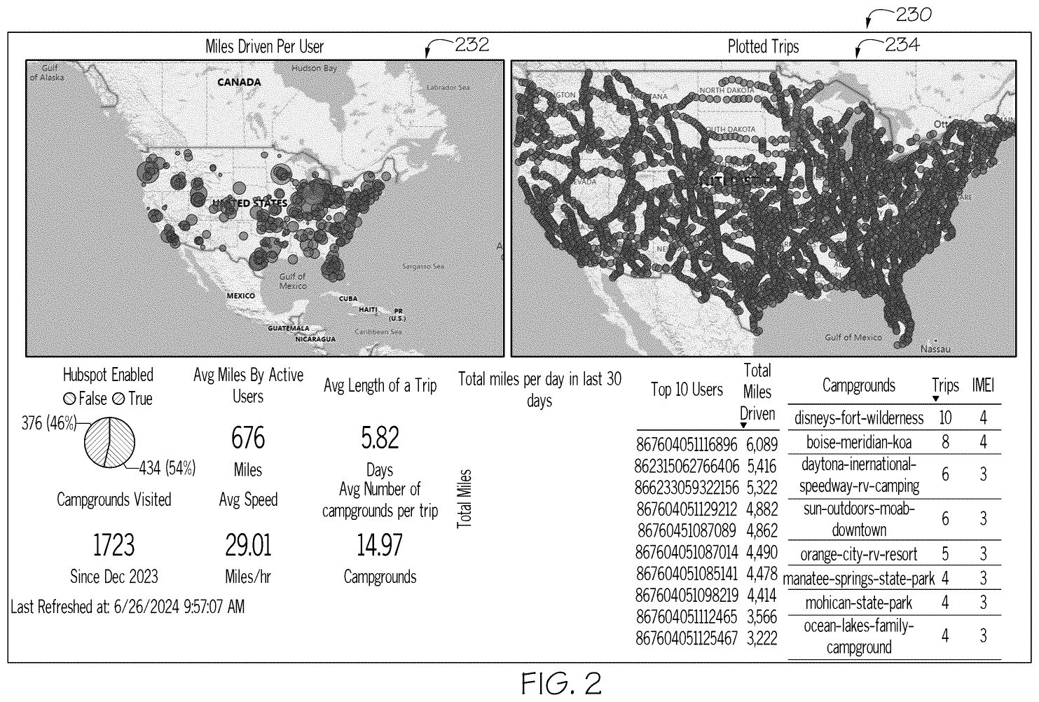

FIG. 2 depicts a user interface for tracking one or more RV users, according to embodiments provided herein;

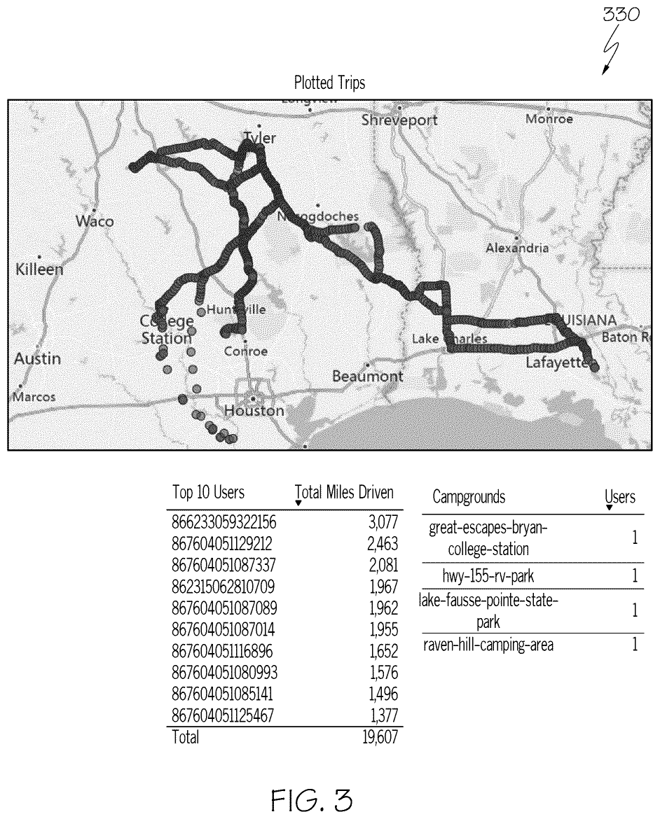

FIG. 3 depicts a user interface for providing plotted trips of one or more RV users, according to embodiments provided herein;

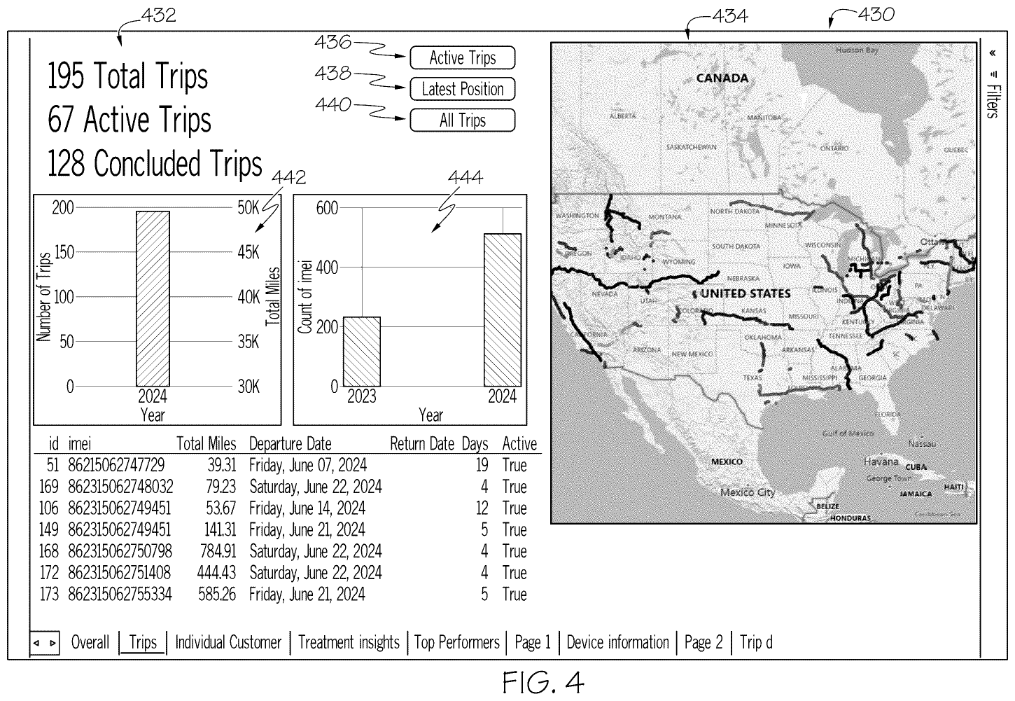

FIG. 4 depicts a user interface for providing active trips of RV users, according to embodiments provided herein;

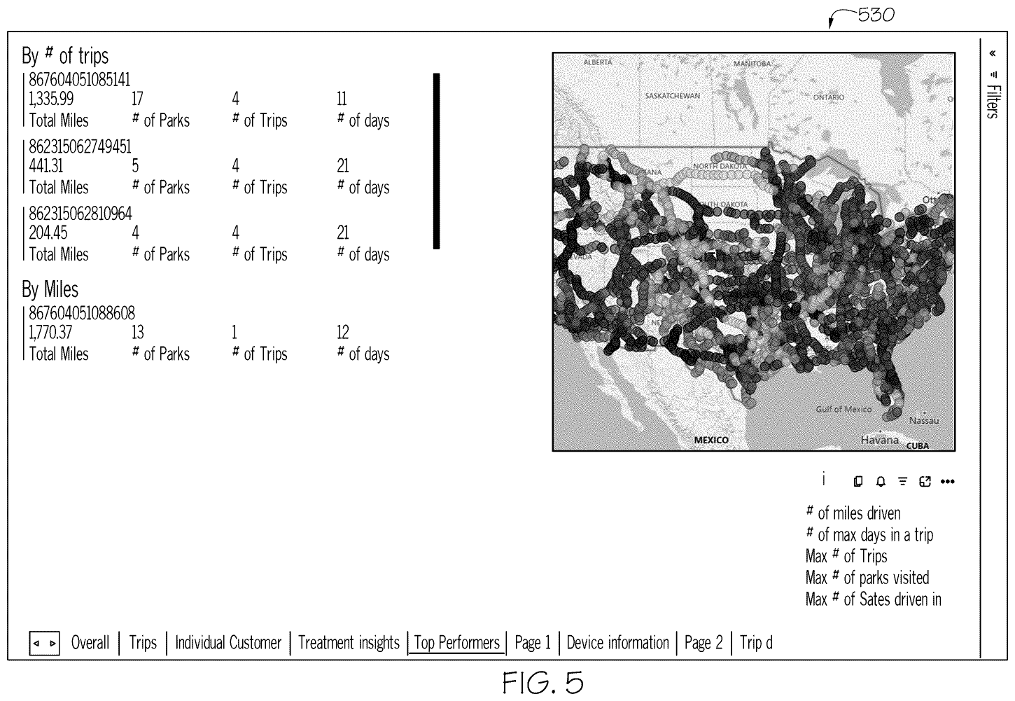

FIG. 5 depicts a user interface for providing trip data of RV users, organized by number of trips, according to embodiments provided herein;

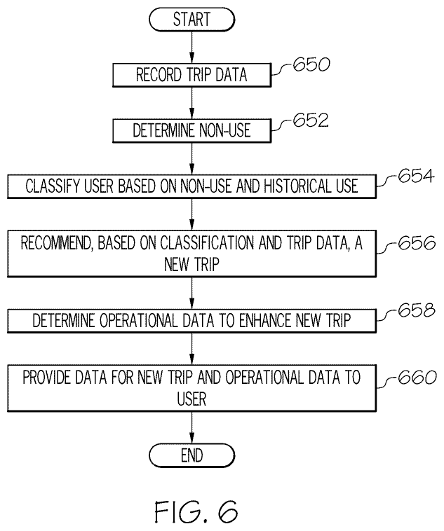

FIG. 6 depicts a flowchart for triggering usage recommendations based on historical geo-location data, according to embodiments provided herein;

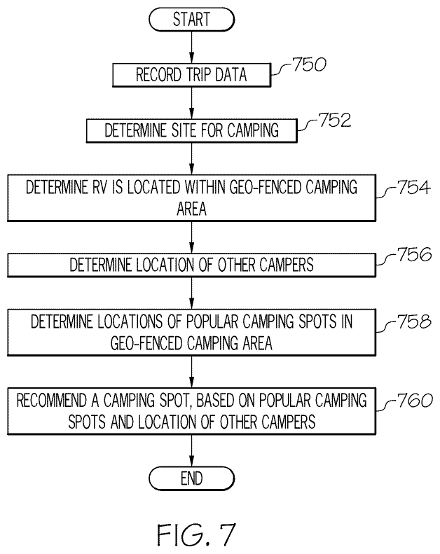

FIG. 7 depicts a flowchart for triggering usage recommendations based on geo-fenced points of interest, according to embodiments provided herein; and

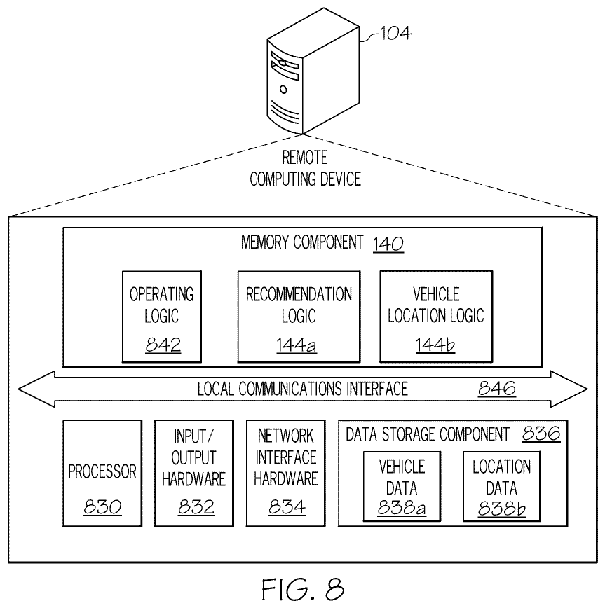

FIG. 8 depicts a remote computing device for triggering usage recommendations based on historical geo-location data, according to embodiments provided herein.

### DETAILED DESCRIPTION

Embodiments disclosed herein include a system and/or method for triggering usage recommendations based on historical geo-location data. Specifically, embodiments may be configured to determine a normal usage pattern of an RV by a user. In response to determining that the user is not using the RV according to his/her normal usage pattern, embodiments may provide recommendations to the user regarding desirable trips and/or campsites. Additionally, some embodiments may be configured to determine which RV assets the user has not operated properly or fully and/or RV assets that the user will likely employ during the recommended trip. If the user responds to the recommended trip, information regarding how to properly use the RV assets may also be provided.

Similarly, some embodiments include a system and/or method for triggering usage recommendations based on geo-fenced points of interest. Specifically, embodiments provided herein are configured to geo-fence a destination, such as a campsite. Once geo-fenced, embodiments may be configured to determine that a user is scheduled to arrive or is arriving at the campsite. These embodiments may additionally determine the locations of other campers at the campsite when the user is arriving. These embodiments may then recommend or provide other data associated with a desirable camping spot, based on the location of other campers and predetermined user preferences. As an example, if a camping spot is identified as a very popular spot, but is currently not crowded, embodiments may recommend this popular camping spot. As another example, if the popular camping spot is fairly crowded, embodiments may determine a user preference regarding the user's tolerance for camping next to other campers. Based on a balance between desirability of the camping spot and user preferences, embodiments may make a recommendation.

Referring now to the drawings, FIG. 1 depicts a computing environment for triggering usage recommendations, according to embodiments provided herein. As illustrated, the computing environment includes a network 100 that couples a recreational vehicle 102, a remote computing device 104, and a mobile device 106. The network 100 may be configured as any wide area network (WAN), such as the internet, cellular network, public switch telephone network (PSTN), satellite network, etc.; local area network (LAN), such as Ethernet, wireless-fidelity (Wi-Fi), etc.; and/or any personal area network (PAN), such as Zigbee™, Bluetooth™, a wired connection, etc.

It should be noted that the term “coupled to” as referred to herein may include being any devices that are physically coupled, electrically coupled, and/or communicatively coupled. As an example, a head unit may be physically coupled to the RV 102, such that the head unit is integral to the RV 102 or may be removably attached to the RV 102. In such an embodiment, the head unit may also be electrically coupled to the RV 102 such that power is provided from the RV 102 to the head unit. Similarly, the head unit may be communicatively coupled to the RV 102 in that the RV 102 may communicate with the head unit to receive and/or provide data.

The RV 102 may be configured as any recreational vehicle, such as a personal travel trailer, a fifth wheel, a lightweight RV, a toy hauler, etc. As such, the RV 102 may be coupled to a towing vehicle and/or may be self-powered. The RV 102 may be configured with a sensor 122 and a vehicle computing device 108. It will be understood that the sensor 122 represents one or more sensors, such as a proximity sensor, a motion sensor, speed sensor, a connection sensor, a tire pressure sensor, hydraulic sensor, taillight sensor, temperature sensor, humidity sensor, a positioning sensor, a camera, operational system sensor and/or other sensor for providing information about the RV 102. The RV 102 may include one or more operational systems 124. The operational system 124 may represent computing infrastructure, a lighting system, a freshwater system, a graywater system, a black water system, a climate control system, a trailed recreational vehicle tire pressure sensor, an appliance (such as a refrigerator, a stove, a dishwasher, a microwave, etc.), a trailed recreational vehicle positioning system, a driver assistance system, a propulsion system, a camera, a communication system, etc. that may be controlled by the user. It should also be noted that although a “recreational vehicle” may take a variety of forms, in its broadest sense, a “recreational” vehicle will comprise a vehicle body enclosing a living quarters equipped with, for example, a sleeping area, a dining area, a food storage area, a food preparation area, personal care areas, or combinations thereof.

The vehicle computing device 108 may be configured as any general purpose or special purpose computer, such as a mobile phone, tablet, laptop, personal computer, head unit, or other mobile or integral computing device to the RV 102. The vehicle computing device 108 may include a memory component 110, which may be configured as volatile or non-volatile memory, such as registers, random access memory (RAM), read-only memory (ROM), flash memory, dynamic RAM, static RAM, cache memory, primary memory, secondary memory, virtual memory, electrically erasable prom (EEPROM), SDRAM, etc. As such, the memory component 110 may store location logic 134a and monitoring logic 134b. The location logic 134a may be configured to cause the vehicle computing device 108 to determine a current location of the RV 102, as well as facilitate storage and organization of past locations of the RV 102. The monitoring logic 134b may be configured to cause the vehicle computing device 108 to monitor usage of the operational system 124 to determine which systems that user utilizes and in which situations.

The remote computing device 104 may represent any general purpose or special purpose server, personal computer, laptop, tablet, and/or other computing device for providing the functionality provided herein. As such, the remote computing device 104 may include hardware and software as provided with reference to FIG. 8, such as a memory component 140, which stores recommendation logic 144a and vehicle location logic 144b. The recommendation logic 144a may cause the remote computing device 104, vehicle computing device 108, and/or the mobile device 106 to receive one or more recommendations for a user. In one example, the recommendation logic 144a may cause the remote computing device 104 to recommend a camping spot. In another example, the recommendation logic 144a may be configured to cause the remote computing device 104 and/or vehicle computing device 108 to recommend a trip for a user to take and/or an operational system 124 to utilize. The vehicle location logic 144b may cause the remote computing device 104 and/or the vehicle computing device 108 to determine a location of one or more RVs and/or other vehicles for providing these recommendations. As such, it will be understood that while the remote computing device 104 in FIG. 1 is depicted as a server, some embodiments may be configured such that the remote computing device 104 includes a display device for providing user interfaces.

It will be understood that while FIG. 1 depicts the vehicle computing device 108 as being provided in the RV 102, some embodiments may include a computing device in addition to or in substitution for the vehicle computing device 108. Specifically, some embodiments may include a head unit in the RV 102 for providing user interfaces, which is not a computer itself, but communicates with the vehicle computing device 108. Some embodiments may be configured such that the vehicle computing device 108 is part of the head unit and is disposed in the RV 102. Some embodiments may be configured such that the head unit is a separate computer from the vehicle computing device 108. Similarly, in some embodiments, the logic described with the remote computing device 104 may be utilized by the vehicle computing device 108 (and vice versa).

The mobile device 106 is also coupled to the network 100. The mobile device 106 may be configured as any general purpose or special purpose computing device that may be moved from a first location to a second location. It will be understood that some embodiments may be configured such that the user interfaces provided in FIGS. 2-5 may be provided by the mobile device 106 and/or the RV 102. In some embodiments, the mobile device 106 may be configured to communicate with the vehicle computing device 108 directly via a PAN network connection. The mobile device 106 may also be configured to communicate with the remote computing device 104 via a WAN connection. As such, while the mobile device 106 is depicted as a mobile phone, it will be understood that a personal computer, laptop, tablet, personal computer, and/or other device may be utilized as the mobile device 106. As an example, the mobile device 106 may be configured as an administrator client device for providing the user interfaces of FIGS. 2-5.

FIG. 2 depicts a user interface 230 for tracking one or more RV users, according to embodiments provided herein. As described above, one or more RVs 102 may be equipped with the sensor 122, an operational system 124, and/or a vehicle computing device 108. With this hardware and software in operation, the RV 102 may be configured to communicate with the remote computing device 104 to determine and/or provide real time or near real time location data to the remote computing device 104. As such, the user interface 230 may be configured to provide location data and other data associated with one or more RVs 102. Specifically, the user interface 230 includes a miles driven per user section 232 and a plotted trips section 234. The miles driven per user section 232 may be configured to provide bubble data, the size and/or color of which may change, based on the number of miles a particular user or group of users have traveled. Also provided are data related to whether a hub spot is enabled, an average number of miles driven by currently active users, an average length of trip, a number of campsites visited, an average speed, and an average of campsites visited per trip. The plotted trips section 234 may be configured to provide a graphical depiction of each of the RV users' trips as a series of bubbles. Also provided are total miles driven, campgrounds visited, a number of trips taken by the top 10 users, and an international mobile equipment identity (IMEI) count.

In some embodiments, the user interface 230 may be provided to a user and/or may be provided only to an administrator or not at all. Regardless, some embodiments may be configured to utilize the complied data to make recommendations and/or perform other functions described in more detail below. More specifically, embodiments may track user A's use of the RV 102 and compare that use with at least a portion of the data from FIG. 2. If user A typically travels 500 miles per year, but has only traveled 100 miles this year, these embodiments may determine that not only is user A 400 miles below his/her average, but is 576 below average across all active users. As such, these embodiments may determine a trip (or a plurality of trips) that is between 400 miles and 576 miles. Embodiments may additionally compare past trips by user A with popular destinations in these ranges to find a new destination for user A or a past destination that user A may want to revisit.

Some embodiments may additionally determine a pattern in user A's trips and plan a trip that continues along the pattern. As an example, if user A's historical data indicated that user A typically takes a trip to a new state every year, but has yet to do so this year, some embodiments may recommend a trip to a state that user A has not visited. Similarly, some embodiments may also compare other user's current trips to determine where trip congestion may be currently occurring and selecting a destination that either meets user A's predetermined congestion level or uses other criteria for making a recommendation.

FIG. 3 depicts a user interface 330 for providing plotted trips of one or more RV users, according to embodiments provided herein. As illustrated, the user interface 330 may be configured to provide data related to plotted trips. Specifically, the user interface 330 may be configured to provide a drill down on the data provided in the plotted trips section 234 of FIG. 2.

As an example, the embodiment of FIG. 3 depicts current trips of five different users. The confirmed plots may be connected dots, whereas the projected trips may be depicted as faded dots and/or unconnected dots. As an example, embodiments may plan a trip for the RV users, but if an RV decides to extend or edit the planned trip, embodiments may be configured to utilize a prediction algorithm to predict where the RV user may be going. Factors in this determination may include historical trips previous searches and/or recommendations, trips of other users, etc.

FIG. 4 depicts a user interface 430 for providing active trips of RV users, according to embodiments provided herein. As illustrated, the user interface 430 may include a data section 432 and a graphical section 434. The data section 432 includes an active trips option 436, a latest position option 438, and an all trips option 440. In response to selection of the active trips option 436, the data section 432 and the graphical section 434 may provide data and imagery associated with active trips of a plurality of users. In response to selection of the latest position option 438, the data section 432 and the graphical section 434 may provide data and imagery related to the latest position of RVs 102. In response to selection of the all trips option 440, the data section 432 and the graphical section 434 may provide respective data for all trips being tracked.

Additionally, the data section 432 may be configured to provide a number of trips graph 442 and a count of IMEI graph 444. The number of trips graph 442 may provide a total number of trips in a given time period. The count of IMEI graph 444 may provide the number of unique users that took trips over a given period of time. Also provided are individual entries for these graphs.

While the data provided in FIG. 4 may be utilized to determine trends of users in taking trips, some embodiments may utilize this data for controlling and/or recommending actions for a user to take. As an example, embodiments may be configured to predict where each of the active users is traveling to determine congestion at campsites. As an example, if it is determined that several users are all expected to camp at the same campsite at the same time, recommendations to other users may identify a different campsite along the recommended trip and/or around the proximity. This may be performed at the time the trip is planned and/or along a trip such that a previously planned trip is altered. Additionally, to the extent that campsites require reservations, some embodiments may be configured to automatically contact the campsite to create, cancel, and/or edit a reservation according to this determination.

FIG. 5 depicts a user interface 530 for providing trip data of RV users, organized by number of trips, according to embodiments provided herein. As illustrated, embodiments of the user interface 530 may provide trip data from a plurality of different users, organized by number of trips. This data may include total number of miles, number of parks, number of trips, number of days for the trips, number of states visited, etc. Graphical data associated with this numerical data may also be provided. As will be understood, this data may be utilized for providing priority and/or additional features to users that meet a predetermined threshold of use. As an example, some embodiments may be configured such that the top 10% of users receive priority reservations on trips, such that if several users are making reservations at once, the users with priority may get the reservation. Similarly, embodiments where trips may be edited while the trip is taking place may be reserved for those users with priority status.

FIG. 6 depicts a flowchart for triggering usage recommendations based on historical geo-location data, according to embodiments provided herein. As illustrated in block 650, past trip data may be recorded. As described above, past trip data may include location data, time data, speed data, destination data, waypoint data, fuel consumption data, etc. for an RV 102 in at least one past trip. From the past trip data, other data may be derived, such as number of states visited, average speed, number of stops made, miles between stops, etc. Additionally, the past trip data may include other trips that the RV 102 has taken in the past. In block 652, a time of non-use may be determined. Specifically, even though the RV 102 may be turned off, a timer may remain activated to determine when the RV 102 is not operational. In some embodiments, the RV 102 may be configured to capture a date and/or time just prior to a shutdown, such that when the RV 102 is restarted, a new time and data may be captured and a determination may be made regarding the duration of non-use of the RV 102.

Some embodiments may additionally be configured to create a threshold for identifying a trip. As an example, if the user takes the RV 102 to the gas station and back home, that may not be considered use that qualifies as a trip. The threshold may be based on destination (e.g., only if a campsite is visited), length of continuous use (e.g., time, distance), amount of time before returning home (e.g., greater than 24 hours), etc. As such, the time of non-use may be time the RV 102 is shutdown and/or time without a qualifying trip may be used for determining time of non-use. Additionally, while time may be a metric, other metrics may be number of usages between trips, miles driven between trips, etc.

In block 654, the user and/or RV 102 may be classified based on the non-use and historical use. As an example, if the RV 102 has not been used for 3 months, but the RV 102 is typically used twice per month, a determination may be made that this is not a typical behavior for this user. Based on this determination, the user may be classified (such as classifying the RV user as a “heavy user,” a “light user,” a “moderate user,” a “lower trending user,” an “upper trending user,” etc.), based on one or more static thresholds, such as more than once per month is classified as a heavy user. In some embodiments, the classification may be based on the RV 102 and/or the user. Depending on the embodiments, an administrator may set criteria for each classification of users. In some embodiments, this classification process may be dynamically determined based on usage of other users. As an example, some embodiments may classify heavy users as the top 10% of users, moderate users 11%-30%, etc. In this embodiment, a user may maintain usage, but may change classifications, based on others' changing usage patterns.

In block 656, a recommendation for a new trip may be provided based on the classification and past trip data. Referring again to the example above, if the user typically travels to Florida in February and the recommendation is being made in February, these embodiments may recommend a trip to Florida. As another example, if the past trip data indicates that the user travels to a different state every trip, these embodiments may recommend a trip to a new state. This recommendation may also utilize data regarding popular campsites and/or other amenities to identify a trip that is likely going to appeal to the user. As another example, some embodiments may be configured to automatically secure reservations with appropriate amenities, such as at campsites, fuel establishments, etc.

In block 658, operational data may be determined to enhance the new trip. The operational data may include functionality data related to the at least one operational system 124 and use data associated with previous use of the operational system 124. Referring again to the example above, if the recommended trip is to Florida, these embodiments may determine operational systems 124 that would be beneficial for that trip (based on the location, distance from current location, time of year, likely stops, etc.) and/or operational systems 124 that the user has not fully utilized in the past (implying that the user lacks a full understanding of the operational system 124). As an example, the operational data could include data related to use of an energy conservation mode, including times the user has activated and/or deactivated the energy conservation mode, an assessment of whether the use was appropriate for the needs of the RV 102, and/or other data.

In block 660, data for the new trip and operational data may be provided to the user. This may include providing options to secure reservations, automatically securing reservations, providing instructional content related to the operational systems 124 from the operational data for the user to understand how the operational system 124 works. Some embodiments may be configured to automatically trigger operation of the operational system 124, based on a predetermined state of the RV 102. As an example, the RV 102 may include a mode that conserves electricity through long camping trips. If the user is planning on camping for multiple days but has not used the energy conservation mode in the past, the RV 102 may be configured to recommend use of the energy conservation mode with details on how best to utilize the system. Some embodiments may determine criteria for using the energy conservation mode and in response to determining that the user does not activate the energy conservation mode, may automatically activate the energy conservation mode (or other operational system 124) to increase efficiency and improve the experience of the trip. As will be understood, this feature may include assessing times that operational system 124 should have been used verses when the system was used and how the system was used. If the RV 102 and/or remote computing device 104 determines that the user is not aware of the operational system 124 and/or does not appear to understand how to properly utilize the operational system 124, the automatic use may be triggered to teach the user and/or to further automate the trip.

It should also be understood that some embodiments may provide the data prior to the trip. As an example, as the RV 102 and/or remote computing device 104 may plan the trip, data may be determined regarding destination, stops, etc., which may be presented to the user for approval and/or editing. In some embodiments, the RV 102 and/or remote computing device 104 may simultaneously recommend operational systems 124 for the user to use and how to properly use those operational systems 124. However, some embodiments may first determine whether the user approves the recommended trip and then provide data and/or instruction regarding the operational systems 124, based on the confirmed trip details.

FIG. 7 depicts a flowchart for triggering usage recommendations based on geo-fenced points of interest, according to embodiments provided herein. As illustrated in block 750, past trip data may be recorded. As described above, past trip data may include historical data associated with trips that a user and/or RV 102 has taken. The past trip data may include location, duration of trip, duration of camping, fuel utilized, energy utilized, operational systems utilized, etc. associated with one or more trips that occurred in the past. In block 752, a location for camping may be determined. The location for camping may include receiving user inputs regarding details of a camping trip and/or embodiments of the remote computing device 104 may be configured to recommend a trip, based on the past trip data. The trip may include camping at a campsite that has been geo-fenced such that certain areas at the campsite may be identified. As an example, a camping area by a lake and/or other popular camping areas may be geo-fenced. These geo-fenced areas may be automatically determined based on past user camping areas and/or may be manually set up by an administrator.

In block 754, a determination may be made regarding whether the RV 102 is located at the campsite. In block 756, a determination may be made regarding whether other RVs 102 are currently located in a geo-fenced area of the campsite. In block 758, a determination may be made regarding popular camping spots in the geo-fenced area of the campsite. In block 760, a camping spot may be recommended, based on the popular camping spots and location of other campers. Specifically, embodiments may be configured to find a camping spot that is highly popular, but not currently overly populated. This determination may include considering user preferences (such as if the user prefers more congested camping spots, rules of the campsite, trip data, etc. Some embodiments may be configured to automatically reserve a camping spot, based on the determination.

FIG. 8 depicts a remote computing device 104 for electronic trailer management and control, according to embodiments provided herein. As illustrated, the remote computing device 104 includes a processor 830, input/output hardware 832, network interface hardware 834, a data storage component 836 (which stores asset data 838a, trip data 838b, and/or other data), and the memory component 140. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the remote computing device 104 and/or external to the remote computing device 104.

The memory component 140 may store operating logic 842, the recommendation logic 144a and the vehicle location logic 144b. The recommendation logic 144a and the vehicle location logic 144b may each include a plurality of different pieces of logic, each of which may be embodied as a computer program, firmware, and/or hardware, as an example. A local interface 846 is also included in FIG. 8 and may be implemented as a bus or other communication interface to facilitate communication among the components of the remote computing device 104.

The processor 830 may include any processing component operable to receive and execute instructions (such as from a data storage component 836 and/or the memory component 140). The input/output hardware 832 may include and/or be configured to interface with microphones, speakers, a display, and/or other hardware.

The network interface hardware 834 may include and/or be configured for communicating with any wired or wireless networking hardware, including an antenna, a modem, LAN port, wireless fidelity (Wi-Fi) card, WiMax card, ZigBee card, Bluetooth chip, USB card, mobile communications hardware, and/or other hardware for communicating with other networks and/or devices. From this connection, communication may be facilitated between the remote computing device 104 and other computing devices, such as the mobile device 106 and/or the vehicle computing device 108.

The operating logic 842 may include an operating system and/or other software for managing components of the remote computing device 104. As also discussed above, the recommendation logic 144a and the vehicle location logic 144b may reside in the memory component 140 and may be configured to perform the functionality, as described herein.

It should be understood that while the components in FIG. 8 are illustrated as residing within the remote computing device 104, this is merely an example, as some embodiments may be configured with the vehicle computing device 108 and/or the mobile device 106 with this hardware and/or software infrastructure to provide the described functionality. It should also be understood that, while the remote computing device 104 is illustrated as a single device, this is also merely an example. In some embodiments, the recommendation logic 144a and the vehicle location logic 144b may reside on different computing devices. As an example, one or more of the functionalities and/or components described herein may be provided by the vehicle computing device 108 and/or mobile device 106.

Additionally, while the remote computing device 104 is illustrated with the recommendation logic 144a and the vehicle location logic 144b as separate logical components, this is also an example. In some embodiments, a single piece of logic (and/or or several linked modules) may cause the remote computing device 104 to provide the described functionality.

Embodiments provided herein include systems and methods for triggering usage recommendations based on historical geo-location data, as well as systems and methods for triggering usage recommendations based on geo-fenced points of interest. As such, these embodiments improve the technical field to RV electronic communications controlling various discrete vehicle systems via trailer hardware and software (and vice versa). As an example, predicting which RV features are associated with camping and which are associated with traveling, the technical filed of RV communications is improved. Further, these systems and methods cannot be performed by a human with pen and paper for at least the reason that it is not detectible to the user which trailed recreational vehicle functions are used.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. Further, the scope of the present disclosure is intended to cover all permutations and sub-permutations of all elements, features, and aspects discussed above. All such modifications and variations are intended to be included herein within the scope of this disclosure.

Therefore, at least the following is claimed:

1. A system for triggering usage recommendations comprising:
a recreational vehicle (RV) for carrying a user that includes at least one operational system, wherein the at least one operational system is configured to provide a function to improve operation of the RV; and
a computing device that includes a processor and memory component, the memory component storing logic, that when executed by the processor, causes the system to perform at least the following:
record past trip data, wherein the past trip data includes data associated with at least one past trip taken in the RV;
determine non-use of the RV, wherein determining non-use of the RV includes determining a duration since a most recent past trip;
classify the RV based on the non-use and the past trip data;
recommend, based on the classification and the past trip data, a new trip for the RV;
determine operational data to enhance the new trip, wherein the operational data is associated with the at least one operational system; and
provide data associated with the new trip and the operational data to the user.

2. The system of claim 1, wherein the logic further causes the RV to automatically trigger operation of the at least one operational system, based on a predetermined state of the RV.

3. The system of claim 1, wherein the logic further causes the system to determine the new trip, wherein determining the new trip includes at least the following:
determine a site for camping;
determine whether the RV is located within a geo-fenced camping area;
determine a location of other campers in the geo-fenced camping area;
determine locations of popular camping areas in the geo-fenced camping area; and
recommend a camping spot based on the popular camping spots and location of other campers.

4. The system of claim 1, wherein past trip data includes at least one of the following: location data, time data, speed data, destination data, waypoint data, or fuel consumption data.

5. The system of claim 1, wherein determining non-use further includes determining a qualifying trip based on a threshold that considers at least one of the following: destination of the past trip, length of continuous use in the past trip, or amount of time before returning home from the past trip.

6. The system of claim 1, wherein classifying the RV includes classifying according to at least one of the following: a heavy user, a light user, a moderate user, a lower trending user, or an upper trending user.

7. The system of claim 1, wherein classifying the RV is based on at least one of the following: static thresholds or other users' usage.

8. The system of claim 1, wherein the operational data includes functionality data related to the at least one operational system and use data associated with previous use of the at least one operational system.

9. The system of claim 1, wherein the computing device includes at least one of the following: a vehicle computing device, a remote computing device, or a mobile device.

10. A method for triggering usage recommendations comprising:
recording, by a computing device, past trip data, wherein the past trip data includes data associated with at least one past trip taken in the RV;
determining, by the computing device, non-use of the RV, wherein determining non-use of the RV includes determining a duration since a most recent past trip;
classifying, by the computing device, a user based on the non-use and the past trip data;
recommending, by the computing device, based on the classification and the past trip data, a new trip for the RV;
determining, by the computing device, operational data to enhance the new trip, wherein the operational data is associated with at least one operational system; and
providing, by the computing device, data associated with the new trip and the operational data to the user.

11. The method of claim 10, further comprising automatically triggering operation of the at least one operational system, based on a predetermined state of the RV.

12. The method of claim 10, further comprising determining the new trip, wherein determining the new trip includes at least the following:
determine a site for camping;
determine whether the RV is located within a geo-fenced camping area;
determine a location of other campers in the geo-fenced camping area;
determine locations of popular camping areas in the geo-fenced camping area; and
recommend a camping spot based on the popular camping spots and location of other campers.

13. The method of claim 10, wherein past trip data includes at least one of the following: location data, time data, speed data, destination data, waypoint data, or fuel consumption data, wherein determining non-use further includes determining a qualifying trip based on a threshold that considers at least one of the following: destination of the past trip, length of continuous use in the past trip, or amount of time before returning home from the past trip, and wherein classifying the user includes classifying according to at least one of the following: a heavy user, a light user, a moderate user, a lower trending user, or an upper trending user.

14. The method of claim 10, wherein classifying the user is based on at least one of the following: static thresholds or other users' usage.

15. The method of claim 10, wherein the operational data includes functionality data related to the at least one operational system and use data associated with previous use of the at least one operational system.

16. A system for triggering usage recommendations comprising:
a computing device that includes a processor and memory component, the memory component storing logic, that when executed by the processor, causes the system to perform at least the following:
record past trip data, wherein the past trip data includes data associated with at least one past trip taken in a recreational vehicle (RV);
determine non-use of the RV, wherein determining non-use of the RV includes determining a duration since a most recent past trip;
classify the RV based on the non-use and the past trip data;
recommend, based on the classification and the past trip data, a new trip for the RV;
determine operational data to enhance the new trip, wherein the operational data is associated with at least one operational system;
provide data associated with the new trip and the operational data to a user; and
automatically trigger operation of the at least one operational system, based on a predetermined state of the RV.

17. The system of claim 16, further comprising the RV for carrying the user that includes the at least one operational system, wherein the at least one operational system is configured to provide a function to improve operation of the RV.

18. The system of claim 16, wherein determining non-use further includes determining a qualifying trip based on a threshold that considers at least one of the following: destination of the past trip, length of continuous use in the past trip, or amount of time before returning home from the past trip.

19. The system of claim 16, wherein past trip data includes at least one of the following: location data, time data, speed data, destination data, waypoint data, or fuel consumption data, wherein classifying the RV includes classifying according to at least one of the following: a heavy user, a light user, a moderate user, a lower trending user, or an upper trending user, and wherein the operational data includes functionality data related to the at least one operational system and use data associated with previous use of the at least one operational system.

20. The system of claim 16, wherein classifying the RV is based on at least one of the following: static thresholds or other users' usage.
